(19) United States
(12) Patent Application Publication
(10) Pub. No.: US 2026/0206797 A1
(43) Pub. Date: Jul. 23, 2026

(54) NON-ALCOHOLIC BEER-TASTE BEVERAGE HAVING SUPPRESSED SOURNESS

(71) Applicant: KIRIN HOLDINGS KABUSHIKI KAISHA, Tokyo (JP)

(72) Inventors: Kazumasa SUNAHARA, Tokyo (JP); Manami SUZUKI, Tokyo (JP)

(73) Assignee: KIRIN HOLDINGS KABUSHIKI KAISHA, Tokyo (JP)

(21) Appl. No.: 19/140,496

(22) PCT Filed: Jul. 31, 2023
(86) PCT No.: PCT/JP2023/027920

§ 371 Date: Jun. 18, 2025

(30) Foreign Application Priority Data
Dec. 23, 2022 (JP) 2022-207319

(51) Int. Cl. A23L 2/38; A23L 2/56

(52) U.S. Cl. CPC A23L 2/382; A23L 2/56

(57) ABSTRACT

Disclosed is a non-alcoholic beer-taste beverage having a content of 5-methyl-2-furfural of 10 ppb or more. The non-alcoholic beer-taste beverage has reduced sourness.

### TECHNICAL FIELD

The present invention relates to a non-alcoholic beer-taste beverage and a method for producing the same.

### BACKGROUND ART

In recent years, the demand for non-alcoholic beer-taste beverages has increased from the viewpoint of health. Non-alcoholic beer-taste beverages have various flavor balance problems due to a low alcohol concentration.

### SUMMARY OF THE INVENTION

The present inventors have found a problem that, in a non-alcoholic beer-taste beverage, a balance of taste originally harmonized with alcohol is lost, and sourness is strong.

As a result of studying the above problem, the inventors have found that sourness in a non-alcoholic beer-taste beverage can be reduced by adjusting a concentration of 5-methyl-2-furfural (CAS: 67-47-0). The present invention is based on this finding.

The present invention provides a non-alcoholic beer-taste beverage having reduced sourness and a method for producing the same.

According to the present invention, the following inventions are provided.
(1) A non-alcoholic beer-taste beverage having a content of 5-methyl-2-furfural of 10 ppb or more.
(2) The non-alcoholic beer-taste beverage according to (1) above, wherein an alcohol (ethanol) concentration is less than 0.005 v/v %.
(3) The non-alcoholic beer-taste beverage according to (1) or (2) above, wherein a content of caprylic acid is 0.3 ppm or more.
(4) The non-alcoholic beer-taste beverage according to (1) or (2) above, wherein a content of capric acid is 0.03 ppm or more.
(5) The non-alcoholic beer-taste beverage according to (1) or (2) above, wherein a content of caprylic acid is 0.3 ppm or more, and a content of capric acid is 0.03 ppm or more.
(6) A method for producing a non-alcoholic beer-taste beverage, the method comprising adjusting a content of 5-methyl-2-furfural in the non-alcoholic beer-taste beverage to 10 ppb or more.
(7) The method according to (6) above, wherein an alcohol (ethanol) concentration of the non-alcoholic beer-taste beverage is less than 0.005 v/v %.
(8) A method for reducing sourness in a non-alcoholic beer-taste beverage, the method comprising adjusting a content of 5-methyl-2-furfural in the non-alcoholic beer-taste beverage to 10 ppb or more.
(9) The method according to (8) above, wherein an alcohol (ethanol) concentration of the non-alcoholic beer-taste beverage is less than 0.005 v/v %.

According to the present invention, it is possible to reduce sourness in a non-alcoholic beer-taste beverage.

### DETAILED DESCRIPTION OF THE INVENTION

In the present invention, the “beer-taste beverage” refers to a beverage having a beer-like flavor. The “beer-like flavor” means that the beverage exhibits a taste and an aroma peculiar to beer obtained when beer is produced in a normal manner, that is, when beer is produced based on fermentation by yeast or the like.

In the present invention, the “non-alcoholic beer-taste beverage” means a beer-taste beverage having an alcohol (ethanol) concentration of less than 1% (v/v). According to a preferred embodiment of the present invention, the alcohol concentration of the non-alcoholic beer-taste beverage of the present invention is less than 0.75% (v/v), more preferably less than 0.5% (v/v), still more preferably less than 0.05% (v/v), still more preferably less than 0.01% (v/v), still more preferably less than 0.009% (v/v), still more preferably less than 0.008% (v/v), still more preferably less than 0.007% (v/v), still more preferably less than 0.006% (v/v), and still more preferably less than 0.005% (v/v).

In the present specification, the unit “ppm” is synonymous with “mg/L”, and the unit “ppb” is synonymous with “μg/L”.

The non-alcoholic beer-taste beverage of the present invention contains 5-methyl-2-furfural in a predetermined concentration range. In addition, according to a preferred embodiment of the present invention, the non-alcoholic beer-taste beverage of the present invention further contains caprylic acid (CAS: 124-07-2) and/or capric acid (CAS: 334-48-5) at a predetermined concentration.

The non-alcoholic beer-taste beverage of the present invention can be produced by adjusting the content of 5-methyl-2-furfural in a process of producing the non-alcoholic beer-taste beverage. In addition, according to a preferred embodiment of the present invention, in the process of producing the non-alcoholic beer-taste beverage of the present invention, a content of caprylic acid and/or capric acid is also adjusted.

The contents of 5-methyl-2-furfural, caprylic acid, and capric acid may be adjusted, in the process of producing a non-alcoholic beer-taste beverage, for example, by adding these substances, by increasing or decreasing the raw materials that provide these substances to a non-alcoholic beer-taste beverage, or by adjusting various conditions (for example, conditions in a preparation step, a saccharification step, a fermentation step, and the like) at the time of production.

A lower limit value of the content of 5-methyl-2-furfural in the non-alcoholic beer-taste beverage of the present invention is 10 ppb, preferably 25 ppb, more preferably 50 ppb, still more preferably 75 ppb, still more preferably 100 ppb, still more preferably 250 ppb, and still more preferably 500 ppb. In the present invention, since it has been demonstrated that 5-methyl-2-furfural exhibits an effect of reducing sourness in a dose-dependent manner, an upper limit value of the content of 5-methyl-2-furfural in the non-alcoholic beer-taste beverage of the present invention is not particularly limited. However, when the upper limit value of the content of 5-methyl-2-furfural is intentionally set, the upper limit value is, for example, 100,000 ppb, preferably 10,000 ppb, more preferably 1,000 ppb, and still more preferably 500 ppb. According to an embodiment of the present invention, the content of 5-methyl-2-furfural in the non-alcoholic beer-taste beverage of the present invention is 10 ppb or more, preferably 10 to 100,000 ppb, more preferably 10 to 10,000 ppb, still more preferably 10 to 1,000 ppb, and still more preferably 10 to 500 ppb.

Quantification of 5-methyl-2-furfural in the beverage can be performed by GC/MS analysis. Specifically, first, aroma ingredients in the beverage may be separated by a C18 solid phase extraction column, and the obtained sample for analysis may be subjected to GC/MS. In addition, borneol can be used as an internal standard substance. As conditions for the GC/MS analysis, for example, conditions shown in Examples can be used. For more accurate concentration measurement, it is desirable to use a calibration curve created based on the measured values of several control samples having known concentrations.

In a preferred embodiment of the present invention, the content of caprylic acid in the non-alcoholic beer-taste beverage of the present invention is 0.3 ppm or more, more preferably 0.5 ppm or more, still more preferably 0.7 ppm or more, and still more preferably 1.0 ppm or more, and is preferably 100 ppm or less, more preferably 50 ppm or less, still more preferably 10 ppm or less, and still more preferably 5.0 ppm or less. In a preferred embodiment of the present invention, the content of capric acid in the non-alcoholic beer-taste beverage of the present invention is 0.03 ppm or more, more preferably 0.06 ppm or more, and still more preferably 0.1 ppm or more, and is preferably 100 ppm or less, more preferably 50 ppm or less, still more preferably 10 ppm or less, and still more preferably 5.0 ppm or less.

Quantification of caprylic acid and capric acid in the beverage can be performed by gas chromatography (GC) with an FID detector. Specifically, aroma ingredients in the beverage may be extracted with a hydroxylated polystyrene divinylbenzene copolymer solid-phase column, and the obtained extraction liquid may be subjected to GC/FID. In addition, as the internal standard substance, trans-2-hexanoic acid and methyl caprylate can be used. As conditions for the GC analysis, for example, conditions shown in Examples can be used. For more accurate concentration measurement, it is desirable to use a calibration curve created based on the measured values of several control samples having known concentrations.

In the non-alcoholic beer-taste beverage of the present invention, other raw materials may be blended as long as the effect of the present invention is not impaired. That is, in the non-alcoholic beer-taste beverage of the present invention, a coloring agent (for example, a caramel dye), a sweetener (for example, a high-intensity sweetener), a seasoning ingredient (for example, an amino acid), a flavoring agent (for example, a commercially available beer flavor containing ethyl acetate, isoamyl acetate, isoamyl alcohol, and the like, which are typical aroma ingredients of beer), a bitter taste ingredient such as an isomerized hop extract, a yeast extract, and the like can be used as raw materials.

A pH (measured at 25° C.) of the non-alcoholic beer-taste beverage of the present invention is preferably 3.5 or more and 4.5 or less, more preferably 3.7 or more and 4.5 or less, still more preferably 3.8 or more and 4.5 or less, and most preferably 3.8 or more and 4.2 or less. The pH of the non-alcoholic beer-taste beverage of the present invention can be adjusted using a pH adjusting agent.

According to a preferred embodiment of the present invention, the non-alcoholic beer-taste beverage of the present invention is a non-alcoholic beer-taste beverage produced by using malt as a raw material, and more preferably a non-alcoholic beer-taste beverage produced by using barley malt as a raw material. According to another preferred embodiment of the present invention, the non-alcoholic beer-taste beverage of the present invention is a non-alcoholic beer-taste beverage produced by using wort as a raw material. According to another preferred embodiment of the present invention, the non-alcoholic beer-taste beverage of the present invention is a non-alcoholic beer-taste beverage produced by using hop as a raw material. According to another preferred embodiment of the present invention, the non-alcoholic beer-taste beverage of the present invention is a beverage in which carbon dioxide gas is dissolved, that is, a non-alcoholic beer-taste carbonated beverage.

The non-alcoholic beer-taste beverage of the present invention can be produced by adjusting the content of 5-methyl-2-furfural at any stage in a common method well known in the art. Examples of such a general method include a method including a preparation step of wort and a filtration step, and the method can be performed, for example, by sequentially performing the steps of: (a) saccharifying and filtering a mixture of pulverized malt and water to obtain wort; (b) adding hop to the obtained wort followed by boiling; (c) cooling the boiled wort; and (d) filtering the cooled wort. Furthermore, examples of such a general method include a method for producing a fermented malt beverage such as beer and then removing alcohol from the obtained fermented malt beverage. Examples of the method for removing alcohol from the beverage include (i) a method in which alcohol and low-boiling-point ingredients are removed by distillation under reduced pressure or atmospheric pressure, (ii) a method in which alcohol and low-molecular-weight ingredients are removed by a reverse osmosis (RO) membrane, and (iii) a method in which volatile ingredients are removed by adsorption to steam using centrifugal force.

According to another aspect of the present invention, there is provided a method for reducing sourness in a non-alcoholic beer-taste beverage, the method including adjusting a content of 5-methyl-2-furfural in the non-alcoholic beer-taste beverage to 10 ppb or more.

### EXAMPLES

Hereinafter, the present invention will be described with reference to Examples, but the present invention is not limited thereto.

### Example 1; Influence of Adjustment of Concentrations of 5-Methyl-2-Furfural, Caprylic Acid, and Capric Acid on Flavor in Non-Alcoholic Beer-Taste Beverage

### (1) Sample Preparation

1 kg of malt was pulverized to an appropriate particle size and placed in a preparation tank, 3 L of warm water was added thereto, the temperature was held at 65° C. for 20 minutes, the temperature was gradually increased, and then, saccharification was performed at 76° C. for 15 minutes. After completion of saccharification, the temperature was increased to 78° C., and then, filtration was performed using filter paper to obtain a filtrate. To 1 L of the filtrate, about 0.1 g of hop was added, and boiling was performed at 100° C. for 60 minutes. The liquid after boiling was filtered using filter paper and cooled to about 5° C. Hot water was appropriately added to the obtained liquid so that a sugar content was 3.0° P to prepare wort. Carbonated water and carbon dioxide gas were added to the wort, and the liquid was stored at 2 to 4° C. for 24 hours and then filtered. A beer-flavored flavoring agent was added to the filtered liquid, and the obtained liquid was used as a base beverage sample A. An alcohol (ethanol) concentration of the base beverage sample A was less than 0.005 v/v %.

In addition, after a fermented malt beverage using malt and hop was produced, the beverage was subjected to an alcohol removal treatment, and then, the obtained liquid was used as a base beverage sample B. Specifically, pulverized malt, an enzyme, and warm water were charged into a preparation tank, and saccharified at a temperature of 60° C. to 78° C. The saccharified liquid was filtered and transferred to a boiling pot, hop was added, and boiling was performed for 70 minutes. After boiling, warm water as much as evaporation was added to the obtained mixture, hot trub was removed in a whirlpool tank, and then, the mixture was cooled to 10° C., thereby obtaining cold wort. Beer yeast was added to the wort, fermentation was performed at around 10° C. for 7 days, and then, the beer yeast was removed. The obtained mixture was transferred to another tank and aged for 7 days, and then cooled to around −1° C. and stabilized for 14 days. Thereafter, degassed water was added to the obtained mixture to dilute the mixture, and the mixture was filtered to obtain a wort fermented liquid. Next, the obtained wort fermented liquid was sprayed into a degassing tank to remove carbon dioxide gas, and then heated to around 50° C. Thereafter, the resultant liquid was brought into contact with water vapor heated to around 50° C. in a column at a reduced pressure of around 60 mbar to adsorb volatile ingredients to the water vapor, such that alcohol and volatile ingredients were removed to obtain an alcohol-removed wort fermented liquid with an alcohol concentration of less than 0.005 v/v %. The alcohol-removed wort fermented liquid was used as a base beverage sample B (less than 0.005 v/v % of alcohol (ethanol) concentration).

In addition, 5-methyl-2-furfural (5MF) and caprylic acid or capric acid were added to the base beverage sample so as to have the concentration described in the following table.

The concentration of 5-methyl-2-furfural (5MF) in each beverage sample in Examples was measured by GC/MS analysis under the following conditions. Specifically, aroma ingredients in the beverage sample were separated by a C18 solid phase column, and the obtained sample for analysis was subjected to GC/MS. Quantification was performed by an internal standard method, and borneol was used as an internal standard substance and added so as to be 50 ppb in the sample for analysis. Conditions for the GC/MS analysis were as shown in the following table.

TABLE 1
GC/MS analysis conditions

| Items | Conditions | |
|---|---|---|
| Equipment name | Agilent Technologies 5977B MSD | |
| Capillary column | HP-INNOWAX | |
| | (length 60 | m, |
| | inner diameter 0.25 | mm, |
| | film thickness 0.25 | μm) |
| Oven temperature | 40° C./0.3 min-(3º C./min) → | |
| | 240° C./20 min | |
| Carrier gas | Helium, 10 | psi |
| | low-pressure ventilation | |
| Transfer line temperature | 240° | C. |
| MS ion source temperature | 230° | C. |
| MSQ pole temperature | 150° | C. |
| Front inlet temperature | 200° | C. |

| Monitoring ions | | Identical to following quantitative ions |
|---|---|---|
| Quantitative | Borneol | 110 |
| ions (m/z) | 5-Methyl-2- | 110 |
| | furfural | |

The measurement of the concentrations of caprylic acid and caproic acid in each beverage in Examples was performed by gas chromatography (GC) with an FID detector. Specifically, aroma ingredients in the beverage were extracted with a hydroxylated polystyrene divinylbenzene copolymer solid-phase column, and the obtained extraction liquid was subjected to GC/FID. In addition, as the internal standard substance, trans-2-hexanoic acid and methyl caprylate were used. Conditions for the GC analysis were as shown in the following table.

TABLE 2
GC analysis conditions

| Column: | Permabond | |
|---|---|---|
| | (length 60 | m, |
| | inner diameter 0.25 | mm, |
| | film thickness 0.25 | μm) |
| Injector temperature: | 275° | C. |
| Column temperature: | 40° C.-5 min → (5° C./min) → 230° C.-35min | |
| Carrier gas: | Helium gas (0.8 | mL/min) |
| Quantitative ion (m/z) | Caprylic acid | (60, 73) |
| | Capric acid | (60, 129) |

### (2) Sensory Evaluation of Tasting Samples

Sensory evaluation by a panel of seven trained people was performed on the tasting sample of each test section prepared in (1) above. The evaluation item of the sensory evaluation was “strength of sourness”. The sensory evaluation was performed in 10 stages in increments of 1 using scores of 1 (sourness is weak) to 10 (sourness is strong).

In the sensory evaluation, the evaluation score of the formulated base beverage sample containing none of 5-methyl-2-furfural (5MF), caprylic acid, and capric acid was fixed to 10, and the evaluation score of the beverage sample containing 10 ppb of 5-methyl-2-furfural (5MF), 0.3 ppm of caprylic acid, and 0.03 ppm of capric acid was fixed to 1.

### (3) Results

The results of sensory evaluation are shown in the following table. The results of the sensory evaluation are shown as the mean and standard deviation of the scores of the seven panelists.

TABLE 3
Sensory evaluation results
Test 1 (using base beverage sample A)

| Test section | | 1 | 2 | 3 | 4 | 5 | 6 | 7 |
|---|---|---|---|---|---|---|---|---|
| 5MF content (ppb) | | 0 | 5 | 10 | 100 | 450 | 1000 | 1500 |
| Strength of | Mean | 10.0 | 9.0 | 5.9 | 4.9 | 3.7 | 3.0 | 2.7 |
| sourness | Standard | 0.00 | 0.76 | 0.83 | 0.35 | 0.70 | 0.76 | 0.45 |
| | deviation | | | | | | | |

Test 2 (using base beverage sample A)

| Test section | | 3 | 8 | 9 | 10 | 11 |
|---|---|---|---|---|---|---|
| 5MF content (ppb) | | 10 | | | | |
| Caprylic acid content (ppm) | | 0 | 0.1 | 0.3 | 5 | 10 |
| Strength of | Mean | 5.9 | 4.4 | 3.3 | 2.6 | 2.0 |
| sourness | Standard | 0.83 | 0.49 | 0.70 | 0.50 | 0.76 |
| | deviation | | | | | |
| Test section | | 4 | 12 | 13 | 14 | 15 |
| 5MF content (ppb) | | 100 | | | | |
| Caprylic acid content (ppm) | | 0 | 0.1 | 0.3 | 5 | 10 |
| Strength of | Mean | 4.9 | 4.7 | 3.7 | 3.1 | 2.3 |
| sourness | Standard | 0.35 | 0.70 | 0.45 | 0.35 | 0.45 |
| | deviation | | | | | |

Test 3 (using base beverage sample A)

| Test section | | 3 | 16 | 17 | 18 | 19 |
|---|---|---|---|---|---|---|
| 5MF content (ppb) | | 10 | | | | |
| Capric acid content (ppm) | | 0 | 0.01 | 0.03 | 5 | 10 |
| Strength of | Mean | 5.9 | 4.4 | 3.6 | 2.9 | 2.3 |
| sourness | Standard | 0.83 | 0.72 | 0.73 | 0.35 | 0.45 |
| | deviation | | | | | |
| Test section | | 4 | 20 | 21 | 22 | 23 |
| 5MF content (ppb) | | 100 | | | | |
| Capric acid content (ppm) | | 0 | 0.01 | 0.03 | 5 | 10 |
| Strength of | Mean | 4.9 | 3.9 | 3.3 | 2.6 | 2.1 |
| sourness | Standard | 0.35 | 0.64 | 0.7 | 0.73 | 0.35 |
| | deviation | | | | | |

Test 4

| | | 24 | 25 |
|---|---|---|---|
| | | (using base | (using base |
| | | beverage | beverage |
| Test section | | sample A) | sample B) |
| 5MF content (ppb) | | 10 | 10 |
| Caprylic acid content (ppm) | | 0.3 | 0.36 |
| Capric acid content (ppm) | | 0.03 | 0.09 |
| Strength of | Mean | 1.0 | 1.4 |
| sourness | Standard | 0.00 | 0.49 |
| | deviation | | |

From the results of Test 1 in Table 3, it was clear that 5-methyl-2-furfural has an effect of reducing sourness, and it was found that the effect is remarkable particularly at a concentration of 10 ppb or more. Next, from the results of Test 2, it was found that when the concentration of caprylic acid was adjusted to 0.3 ppm or more, in addition to 5-methyl-2-furfural, the sourness reducing effect becomes more remarkable. In addition, from the results of Test 3, it was found that when the concentration of capric acid was adjusted to 0.03 ppm or more, in addition to 5-methyl-2-furfural, the sourness reducing effect becomes more remarkable. Furthermore, from the results of Test 4, it was found that an excellent sourness reducing effect can be obtained by adjusting the concentration of the combination of 5-methyl-2-furfural, caprylic acid, and capric acid.

1. A non-alcoholic beer-taste beverage having a content of 5-methyl-2-furfural of 10 ppb or more.

2. The non-alcoholic beer-taste beverage according to claim 1, wherein an alcohol (ethanol) concentration is less than 0.005 v/v %.

3. The non-alcoholic beer-taste beverage according to claim 1, wherein a content of caprylic acid is 0.3 ppm or more.

4. The non-alcoholic beer-taste beverage according to claim 1, wherein a content of capric acid is 0.03 ppm or more.

5. The non-alcoholic beer-taste beverage according to claim 1, wherein a content of caprylic acid is 0.3 ppm or more, and a content of capric acid is 0.03 ppm or more.

6. A method for producing a non-alcoholic beer-taste beverage, the method comprising adjusting a content of 5-methyl-2-furfural in the non-alcoholic beer-taste beverage to 10 ppb or more.

7. The method according to claim 6, wherein an alcohol (ethanol) concentration of the non-alcoholic beer-taste beverage is less than 0.005 v/v %.

8. A method for reducing sourness in a non-alcoholic beer-taste beverage, the method comprising adjusting a content of 5-methyl-2-furfural in the non-alcoholic beer-taste beverage to 10 ppb or more.

9. The method according to claim 8, wherein an alcohol (ethanol) concentration of the non-alcoholic beer-taste beverage is less than 0.005 v/v %.

10. The non-alcoholic beer-taste beverage according to claim 2, wherein a content of caprylic acid is 0.3 ppm or more.

11. The non-alcoholic beer-taste beverage according to claim 2, wherein a content of capric acid is 0.03 ppm or more.

12. The non-alcoholic beer-taste beverage according to claim 2, wherein a content of caprylic acid is 0.3 ppm or more, and a content of capric acid is 0.03 ppm or more.
